(19) United States
(12) Patent Application Publication
(10) Pub. No.: US 2024/0399752 A1
(43) Pub. Date: Dec. 5, 2024

(54) LIQUID EJECTION HEAD

(71) Applicant: CANON KABUSHIKI KAISHA, Tokyo (JP)

(72) Inventors: YASUAKI KITAYAMA, Kanagawa (JP); CHIAKI MURAOKA, Saitama (JP); TOMOAKI KAMAGATA, Kanagawa (JP)

(21) Appl. No.: 18/678,508

(22) Filed: May 30, 2024

(30) Foreign Application Priority Data
Jun. 1, 2023 (JP) 2023-090882

(51) Int. Cl. B41J 2/175; B41J 2/14

(52) U.S. Cl. CPC B41J 2/175; B41J 2/14

(57) ABSTRACT

The liquid ejection head includes: a first element substrate having a first orifice row formed by a plurality of orifices aligned along a first direction, and a first pressure chamber; a second element substrate having a second orifice row formed by a plurality of orifices aligned along the first direction, and a second pressure chamber; and a channel-forming member including a plurality of reservoirs storing liquid. At least a portion of the second orifice row is adjacent to the first orifice row in a second direction perpendicular to the first direction. The reservoirs include a first reservoir in communication with the first pressure chamber and the second pressure chamber, a second reservoir in communication with the first pressure chamber, and a third reservoir in communication with the second pressure chamber.

### BACKGROUND OF THE INVENTION

### Field of the Invention

The present invention relates to a liquid ejection head.

### Description of the Related Art

A conventionally known liquid ejection head that records an image on a recording medium such as paper is configured to eject liquid such as ink onto the recording medium from a recording element substrate that has channels formed therein. In an inkjet recording apparatus with such a liquid ejection head, the image is recorded on the recording medium by liquid droplets ejected from orifices of the recording element substrate and landing at desired positions on the recording medium.

Japanese Patent Application Publication No. 2017-19153 discloses a configuration in which plural ejection units each equipped with a recording element substrate are arranged along the conveying direction and the width direction of the recording medium, so that the orifices are arranged in multiple rows and that the apparent length of the rows of orifices is increased.

### SUMMARY OF THE INVENTION

In the above configuration, the recording element substrate is provided to each ejection unit. Channels for supplying liquid to the recording element substrates are formed in respective ejection units. In such a configuration, with an increase in the number of recording element substrates, more channels need to be formed, and therefore the liquid ejection head tends to become larger.

To solve the above problem, an object of the present invention is to provide a liquid ejection head that has a plurality of recording element substrates and can suppress size increase.

To achieve the above object, the liquid ejection head according to the present invention includes:
a first element substrate including a first orifice row formed by a plurality of orifices, which are configured to eject liquid and are aligned along a first direction, and a first pressure chamber provided correspondingly to an orifice of the first orifice row;
a second element substrate including a second orifice row formed by a plurality of orifices, which are configured to eject liquid and are aligned along the first direction, the second orifice row having at least a portion that is adjacent to the first orifice row in a second direction perpendicular to the first direction, and a second pressure chamber provided correspondingly to an orifice of the second orifice row; and
a channel-forming member including a plurality of reservoirs storing liquid, the plurality of reservoirs comprise a first reservoir in communication with the first pressure chamber and the second pressure chamber, a second reservoir in communication with the first pressure chamber, and a third reservoir in communication with the second pressure chamber.

Furthermore, to achieve the above object, the liquid ejection head according to the present invention includes:
a first element substrate including a first orifice row formed by a plurality of orifices, which are configured to eject liquid and are aligned along a first direction, a first pressure chamber provided correspondingly to an orifice of the first orifice row, a second orifice row formed by a plurality of orifices, which are configured to eject liquid and are aligned along the first direction, and a second pressure chamber provided correspondingly to an orifice of the second orifice row;
a second element substrate including a third orifice row formed by a plurality of orifices, which are configured to eject liquid and are aligned along the first direction, the third orifice row having at least a portion that is adjacent to the second orifice row in a second direction perpendicular to the first direction, a third pressure chamber provided correspondingly to an orifice of the third orifice row, a fourth orifice row formed by a plurality of orifices, which are configured to eject liquid and are aligned along the first direction, and a fourth pressure chamber provided correspondingly to an orifice of the fourth orifice row; and
a channel-forming member including a plurality of reservoirs storing liquid, the plurality of reservoirs comprise a first reservoir in communication with the first pressure chambers and the third pressure chambers, a second reservoir in communication with the second pressure chambers, and a third reservoir in communication with the fourth pressure chambers.

According to the present invention, a liquid ejection head that has a plurality of recording element substrates and can suppress size increase, can be provided.

Further features of the present invention will become apparent from the following description of exemplary embodiments with reference to the attached drawings.

### BRIEF DESCRIPTION OF THE DRAWINGS

FIG. 1 is an exploded perspective view of a liquid ejection head according to a first embodiment;

FIG. 2 is an exploded perspective view of a liquid ejection unit according to the first embodiment;

FIGS. 3A and 3B are illustrative diagrams explaining the effect that reduces pressure loss, and the effect that improves the efficiency of removing air bubbles in channels;

FIGS. 4A and 4B are schematic cross-sectional views of a recording element substrate according to the first embodiment;

FIGS. 5A to 5D are illustrative diagrams of a channel configuration in the liquid ejection unit according to Example 1;

FIGS. 6A to 6D are illustrative diagrams of a channel configuration in the liquid ejection unit according to Example 2;

FIGS. 7A to 7D are illustrative diagrams of a channel configuration in the liquid ejection unit according to Example 3;

FIGS. 8A to 8F are illustrative diagrams of a channel configuration in the liquid ejection unit according to Example 4;

FIGS. 9A and 9B are illustrative diagrams of a channel configuration in the liquid ejection unit according to Example 5; and

FIGS. 10A and 10B are illustrative diagrams of a channel configuration in the liquid ejection unit according to Example 6.

### DESCRIPTION OF THE EMBODIMENTS

Hereinafter, a description will be given, with reference to the drawings, of embodiments (examples) of the present invention. However, the sizes, materials, shapes, their relative arrangements, or the like of constituents described in the embodiments may be appropriately changed according to the configurations, various conditions, or the like of apparatuses to which the invention is applied. Therefore, the sizes, materials, shapes, their relative arrangements, or the like of the constituents described in the embodiments do not intend to limit the scope of the invention to the following embodiments.

### First Embodiment

### Configuration of Liquid Ejection Head

First, a liquid ejection head 10 according to a first embodiment of the present invention will be described. The liquid ejection head 10 is an inkjet recording head that records an image on a recording medium by ejecting ink as the liquid, and provided in a recording apparatus such as an inkjet printer.

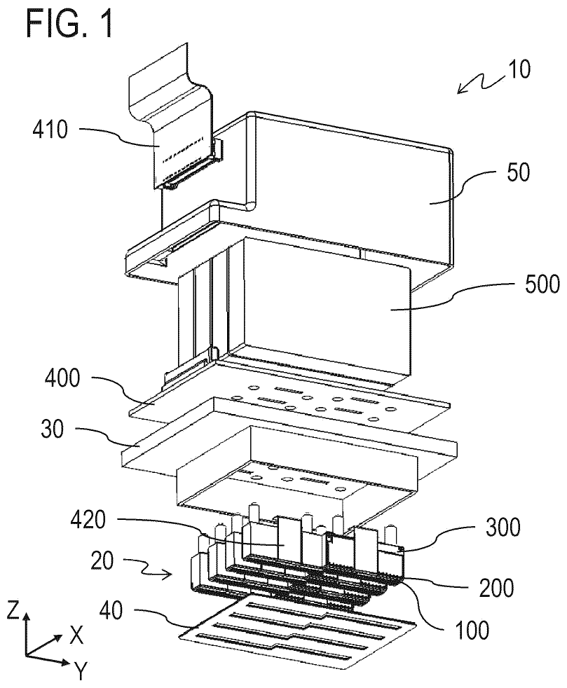

FIG. 1 is an exploded perspective view of a configuration example of the liquid ejection head 10 according to the present invention. The liquid ejection head 10 includes a recording element substrate 100, a connection member 200, a channel member 300, an electric circuit substrate 400, and a sub tank unit 500. In the following description, the scanning direction of the liquid ejection head 10 when the liquid ejection head 10 is mounted in a recording apparatus will be referred to as the X direction. The direction in which the recording medium facing the liquid ejection head 10 is conveyed will be referred to as the Y direction. The direction in which the ink is ejected from the liquid ejection head 10 will be referred to as the Z direction. In the first embodiment, the Y direction (first direction) is parallel to the longitudinal direction of the recording element substrate 100, and the X direction (second direction) is parallel to the short-side direction of the recording element substrate 100.

The sub tank unit 500 stores therein the ink that is supplied from the outside of the liquid ejection head 10 to be used for the image recording. The sub tank unit 500 includes a pressure regulation mechanism to also serve the function of controlling the pressure in the channels of the liquid ejection head 10. While the liquid ejection head 10 described below as one application example of the present invention includes the sub tank unit 500 to which ink is supplied from the outside, the present invention is also applicable to other configurations than this. For example, the present invention is applicable also to a configuration where an ink cartridge is set inside the liquid ejection head 10.

Channels are formed in each of the recording element substrate 100, connection member 200, and channel member 300 for the ink to flow through. The ink stored in the sub tank unit 500 is supplied to the recording element substrate 100 via the channel member 300, and the connection member 200 that connects the respective channels of the channel member 300 and the recording element substrate 100. The ink supplied to the recording element substrate 100 is ejected when energy-generating elements in the recording element substrate 100 are driven.

Signals that drive the energy-generating elements are generated by the recording apparatus in which the liquid ejection head 10 is mounted, and received by the electric circuit substrate 400 via an electric connection member (flexible cable) 410. The signal received by the electric circuit substrate 400 is transmitted to the recording element substrate 100 via an electric wiring member 420 so that the energy-generating element in the recording element substrate 100 is driven.

The liquid ejection head 10 includes a plurality of liquid ejection units 20 each composed of the channel member 300, connection member 200, recording element substrate 100, and electric wiring member 420. The liquid ejection units 20 are each fixed to a frame 30 or a face cover 40 and form part of the liquid ejection head 10. The liquid ejection units 20 are precisely positioned and secured to the frame 30 or face cover 40 with an adhesive or the like. The sub tank unit 500 is covered by a head cover 50 all around, which is fitted from above.

FIG. 1 shows a liquid ejection head 10 with four liquid ejection units 20 as the first embodiment. It should be noted that in applications of the present invention, the liquid ejection head 10 may be configured with less than four, or five or more, liquid ejection units 20 aligned on the XY plane.

### Configuration of Liquid Ejection Unit

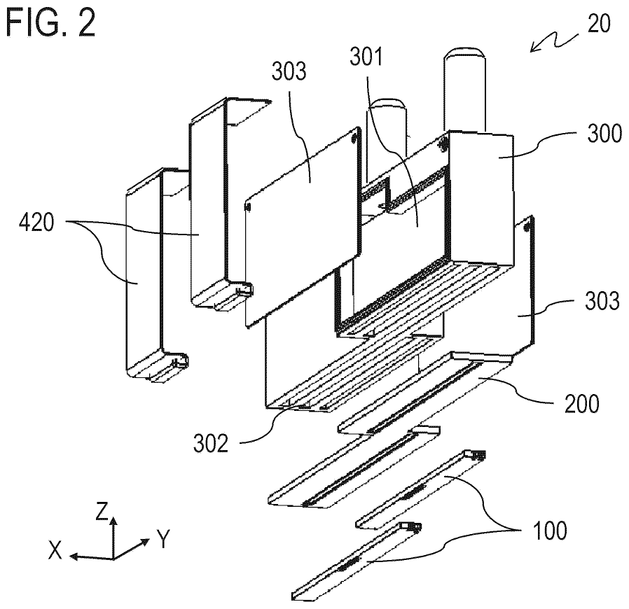

Next, the configuration of the liquid ejection unit 20 will be described in more detail. FIG. 2 is an exploded perspective view of the liquid ejection unit 20, illustrating one configuration example of the liquid ejection unit 20. The liquid ejection unit 20 in the first embodiment includes a plurality of recording element substrates 100, a connection member 200 to which the recording element substrates 100 are connected, and a channel member 300 to which the connection member 200 is connected. In other words, the plural recording element substrates 100 are connected to one end portion of the connection member 200, and the channel member 300 is connected to the other end portion of the connection member 200.

The channel member 300 includes a plurality of reservoirs 301 that stores liquid; it is a channel-forming member mainly made of resin and formed with ink channels inside. The reservoirs 301 are each formed with a reservoir opening 302 on the ejection side of the channel member 300 (where the connection member 200 is connected). The recording element substrates 100 are Si wafer components carrying the energy-generating elements and formed with channels by a semiconductor process. Positioning the reservoirs 301 that store the liquid closer to the recording element substrates 100 than to the sub tank unit 500 mitigates the adverse effects of pressure loss and improves ejection stability.

There is a large difference in producible thickness between the channel member 300 that is mainly made of resin and the recording element substrate 100 made of Si. For example, while the limit of the thickness of resin is generally about 0.6 mm, Si can be reduced to a thickness of 0.1 mm or less.

On the other hand, the unit price of the resin-made channel member 300 is relatively inexpensive irrespective of the size, whereas the recording element substrate 100 is relatively expensive, as it is produced through semiconductor processes to provide various functions such as heaters and channels in multiple layers. Accordingly, it is preferable to reduce the size of the recording element substrate 100 in order to minimize cost increases in the production of the liquid ejection head 10.

An inkjet printer uses fluids that contain many chemical components such as solvents, because of which the channel-forming portions are constantly subjected to chemical stress. To prevent destruction of the channel-forming components, it is preferable for the channel member 300 to have a thickness of about 1.5 mm, and for the recording element substrate 100 to have a protection film. Such measures against chemical stress can further increase the size difference between the channel member 300 and the recording element substrate 100.

To connect these components with largely differing sizes in fluid communication, the connection member 200, which is produced from a Si wafer, is connected to the liquid ejection head 10 and the channel member 300 for channel pitch conversion. Unlike the recording element substrate 100, the production of the connection member 200 is relatively inexpensive since it only needs to be formed with channels. The channel member 300 and connection member 200, and the connection member 200 and recording element substrates 100, are each bonded together with adhesive, so that their channels are connected to each other. The method of joining these components together is not limited to bonding. For example, they may be fastened together with an interposed elastic member using screws.

The plural liquid ejection units 20 are arranged along the X direction (scanning direction) in the liquid ejection head 10. This configuration allows the liquid ejection head 10 to eject inks of any desired number of colors. For size reduction of the liquid ejection head 10 with such a configuration, it is preferable to make each of the liquid ejection units 20 as thin as possible in the X direction. In the first embodiment, a portion of an inner wall of the reservoirs 301 in the channel member 300 is formed by a metal sheet 303. The metal sheet 303 is fixedly bonded to a resin member. The metal sheet 303 can withstand chemical stress with a thickness of about 0.2 mm. Thus the channel member 300 is composed of a resin material, and the metal material that forms a portion of the wall of the reservoirs 301. By forming a portion of the wall of the channel member 300 with the metal sheet 303, the channel member 300 can be made thinner than if the channel member 300 were made solely of a resin member.

A liquid ejection head configured to integrate multiple liquid ejection units therein offers the advantage of allowing flexible selection of the number of liquid ejection units. On the other hand, the precision of relative positions of the recording element substrates is compromised. When the plural recording element substrates are displaced from each other in order to extend the apparent length of nozzle rows, the precision of the relative positions of the recording element substrates is particularly important. For example, when using two recording element substrates to extend the length of nozzle rows, if the orifices of each recording element substrate are oriented in different directions, there will be variation in the state of liquid landing on the recording medium between the upper half and the lower half of one scan, resulting in non-uniformity in the image known as banding.

Some conventionally known liquid ejection heads are configured to have a plurality of recording element substrates mounted on an integral support member. This configuration allowed for a simple design and facilitated precise positioning of the recording element substrates, since the substrates that are relatively high precision parts are bonded to a single component (support member). In comparison, a liquid ejection head configured to integrate multiple liquid ejection units therein requires assembling of the ejection units, which are larger than recording element substrates and composed of more components, to another integral component. Therefore, this configuration is more prone to increased tolerances and poorer precision both in terms of size and the number of components. To resolve this issue, sometimes, a mechanism for allowing adjustment of each liquid ejection unit is provided, or, a larger high-precision housing component is used for integrating multiple liquid ejection units. However, these measures entail disadvantages such as increased design complexity and cost increases.

In the liquid ejection unit 20 of the first embodiment, to extend the apparent length of nozzle rows, plural recording element substrates 100 are bonded to an integral connection member 200 that has high planarity. This configuration makes it easier to keep precise positions of the recording element substrates 100 relative to each other, which is particularly important.

When extending the apparent nozzle row length by providing two or more recording element substrates, it is necessary to arrange the recording element substrates such that their orifice rows (nozzle rows) overlap in the Y direction (direction in which the recording medium is conveyed). Therefore, to extend the apparent nozzle row length by providing a plurality of liquid ejection units each having a single recording element substrate, the liquid ejection head tends to have a large width in the X direction (scanning direction), because of the channel-forming members separately provided above respective recording element substrates.

Accordingly, in the liquid ejection unit 20 of the first embodiment, the channel member 300 and the connection member 200 are integrated in the portion where the rows of orifices overlap. This configuration allows the spacing in the X direction of the plural recording element substrates 100 to be narrower, thus minimizing an increase in the width in the X direction of the liquid ejection head 10.

### Mitigation of Pressure Loss and Improved Efficiency in Removing Air Bubbles in Channels

Next, the channel configuration for mitigating pressure loss and for improving the efficiency of removing air bubbles generated inside the channels will be described. The ink flows from the channel member 300 to the recording element substrates 100 via the connection member 200. The reservoirs 301 are each formed with a reservoir opening 302 that connects to the channel inside the connection member 200. The recording element substrates 100 are each formed with a shared supply path 102 as a channel opening that connects to the channel inside the connection member 200. The reservoir openings 302 of the reservoirs 301 and the shared supply paths 102 of the recording element substrates 100 both have an oblong or oval cross-sectional shape with longer sides extending in the longitudinal direction (Y direction) of the recording element substrate 100. The connection member 200 has a liquid supply opening 201, which connects the reservoir openings 302 of the reservoirs 301 and the shared supply paths 102 of the recording element substrates 100, and this opening similarly has an oblong or oval cross-sectional shape with longer sides extending in the longitudinal direction (Y direction) of the recording element substrate 100. This shape of these openings is designed to mitigate pressure loss and to improve the efficiency of removing air bubbles in the channels.

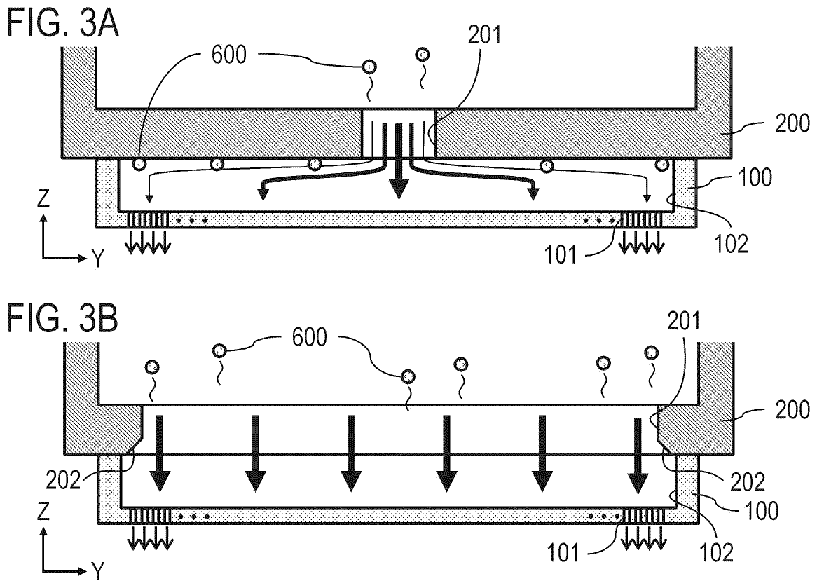

Referring now to FIGS. 3A and 3B, the effect that reduces pressure loss, and the effect that improves the efficiency of removing air bubbles in the channels, will be described in more detail. FIGS. 3A and 3B are illustrative diagrams of the ink channels in a comparative example and the first embodiment. FIG. 3A is a schematic cross-sectional view of the ink channel according to the comparative example as viewed in the X direction, and FIG. 3B is a schematic cross-sectional view of the ink channel according to the first embodiment as viewed in the X direction. In the comparative example, the liquid supply opening 201 of the connection member 200 is narrow in the longitudinal direction (Y direction) in comparison to the first embodiment.

First, the effect that reduces pressure loss is described in more detail. The recording element substrate 100 is formed with multiple pressure chambers 101 aligned along the longitudinal direction, corresponding to respective orifices for ejecting ink. The ink is supplied to respective pressure chambers 101 via the shared supply path 102. When the liquid supply opening 201 is narrower in the longitudinal direction than the shared supply path 102, as shown in FIG. 3A, there is a variation in distance from the liquid supply opening 201 to each pressure chamber 101 depending on the position of the pressure chamber 101. A variation in the length of ink supply path in the longitudinal direction of the recording element substrate 100 results in a variation in the fluid volume supplied to each pressure chamber 101 due to pressure loss difference, which may eventually cause non-uniform tinges of colors of the prints. Such non-uniformity stands out in an undesirable manner when printing photographs or posters where fluid is ejected onto one surface, and results in poor quality.

When the liquid supply opening 201 is wide in the longitudinal direction as shown in FIG. 3B, there is less variation among the supply paths to the pressure chambers 101 aligned along the longitudinal direction, so that the variation in the fluid volume supplied to each pressure chamber 101 can be made smaller. In order to supply ink with minimum possible pressure loss, it is preferable that the liquid supply opening 201 is open over the entire length of the rows of orifices. Given the advancement in ink performance and functionality, there may be a case where a high-viscosity ink is used in the recording apparatus. In case such an ink is used, it is preferable to reduce the pressure loss in the channels as much as possible.

Next, the effect that improves the efficiency of removing air bubbles in the channels will be described in more detail. The liquid ejection head 10 according to the first embodiment adopts a thermal inkjet technique, so that air bubbles 600 may form in the ink due to a temperature change. Air bubbles 600 present around the orifices may adversely affect ink ejection and deteriorate the quality of the print, and therefore need to be kept away from the orifices. When the liquid supply opening 201 is narrower in the longitudinal direction than the shared supply path 102, as shown in FIG. 3A, the portion other than the liquid supply opening 201 forms a ceiling of the channel. The air bubbles 600 are pushed up by buoyancy and stopped by the ceiling; the air bubbles 600 thus can accumulate inside the recording element substrate 100.

Preferably, stagnant air bubbles should not be present near the pressure chambers 101 as mentioned above. Therefore, the channels in the liquid ejection head 10 should preferably be designed to cause air bubbles 600 to move away from the pressure chambers 101 by buoyancy. The connection member 200 of the first embodiment with the liquid supply opening 201 having an increased width in the longitudinal direction as shown in FIG. 3B is therefore configured to cause air bubbles 600 that formed in the recording element substrate 100 to move away by themselves from the pressure chambers 101 due to buoyancy. Moreover, slopes 202 at the lower end of the liquid supply opening 201 further help the air bubbles 600 to rise up smoothly by buoyancy in the upper part of the recording element substrate 100. Namely, the connection member 200 with the slopes 202 has a connection channel inside, one end portion of which is configured to increase in width in the longitudinal direction toward the recording element substrate 100.

While the openings in the channel member 300, connection member 200, and recording element substrate 100 described above are all single openings, they may have a frame structure and be configured as a plurality of independent openings.

### Flows of Liquid Around Pressure Chambers

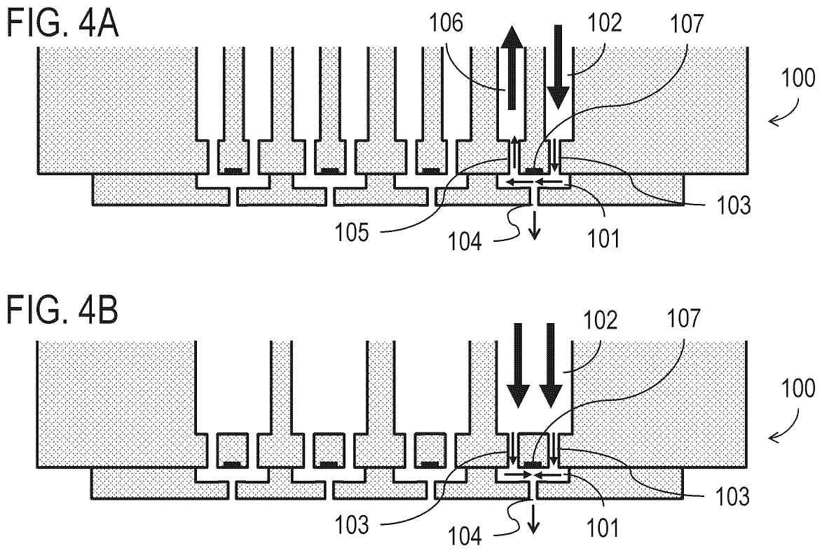

Next, the flows of liquid around the pressure chambers 101 in the recording element substrate 100 will be described. The present invention is applicable to either of the configuration where ink is circulated inside the liquid ejection head 10 and the configuration where ink is not circulated. Therefore, the liquid flows in the case of circulating the ink inside the liquid ejection head 10 and in the case of not circulating the ink will be described separately. FIGS. 4A and 4B are illustrative diagrams of liquid flows inside the recording element substrate 100. FIG. 4A is a schematic cross-sectional view of a configuration example of the recording element substrate 100 in which fluid is circulated inside the liquid ejection head 10, seen from the Y direction. FIG. 4B is a schematic cross-sectional view of a non-circulatory configuration example of the recording element substrate 100 in which fluid is not circulated inside the liquid ejection head 10, seen from the Y direction. The arrows in FIGS. 4A and 4B indicate the directions of ink flow inside the recording element substrate 100. Note, the flow of liquid around one pressure chamber 101 described below applies similarly to all of the pressure chambers 101.

First, the liquid flow in a circulatory configuration will be described with reference to FIG. 4A. A liquid supply path is formed by a shared supply path 102, a supply port 103, and a pressure chamber 101. The supply port 103 is a channel that communicates the shared supply path 102 and the pressure chamber 101. The ink supplied to the shared supply path 102 via the channel member 300 and connection member 200 flows through the supply port 103 into the pressure chamber 101. The channels in the liquid ejection head 10 are configured such that each reservoir 301 of the channel member 300 is in communication with one of the pressure chambers 101, so that the ink flows between the sub tank unit 500 and the pressure chambers 101 via the reservoirs 301.

The recording element substrate 100 is formed with energy-generating elements 107 corresponding to respective pressure chambers 101 for ejecting ink. The ink supplied to the pressure chambers 101 is ejected toward the recording medium through the orifices 104 or nozzles when the energy-generating elements 107 are driven. Some of the ink that was not ejected from the orifices 104 flows into a liquid collection path.

The liquid collection path is formed by a pressure chamber 101, a collection port 105, and a shared collection path 106. The collection port 105 is a channel that communicates the pressure chamber 101 with the shared collection path 106. The shared collection path 106 is an elongated opening extending in the longitudinal direction of the shared supply path 102 and connected to the plurality of pressure chambers 101 via the collection ports 105. Some of the ink supplied to the pressure chambers 101 that was not ejected from the orifice 104 flows through the collection ports 105 into the shared collection path 106. The liquid inside the shared collection path 106 is then collected in the sub tank unit 500 or the main body of the recording apparatus via the connection member 200 and channel member 300.

Next, the liquid flow in a non-circulatory configuration will be described with reference to FIG. 4B. A liquid supply path is formed by a shared supply path 102, a supply port 103, and a pressure chamber 101. There may be a plurality of supply ports 103 for one pressure chamber 101. The ink supplied to the shared supply path 102 via the channel member 300 and connection member 200 flows through the supply port 103 into the pressure chamber 101. The liquid supplied to the pressure chamber 101 is consumed only through the orifice 104.

### Channel Configuration of Liquid Ejection Unit

Next, the ink channel configuration of the liquid ejection unit 20 will be illustratively described based on several examples. Below, several examples of the liquid ejection head 10 according to the first embodiment, in which the layout of the recording element substrates 100 and the circulatory configuration of the liquid ejection head 10 are varied, will be described.

### First Example

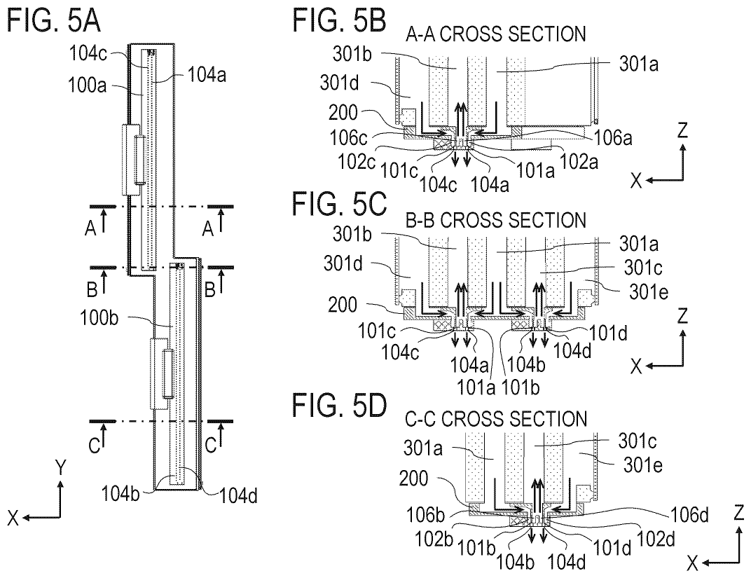

The channel configuration of the liquid ejection unit 20 according to Example 1 will be described with reference to FIGS. 5A to 5D. FIGS. 5A to 5D are illustrative diagrams of the channel configuration in the liquid ejection unit 20 according to Example 1. FIG. 5A is a bottom view of the liquid ejection unit 20. FIG. 5B is an A-A cross section of FIG. 5A. FIG. 5C is a B-B cross section of FIG. 5A. FIG. 5D is a C-C cross section of FIG. 5A. The arrows in FIGS. 5B to 5D indicate the directions of the flow of ink.

In Example 1, the liquid ejection unit 20 includes a first element substrate 100a and a second element substrate 100b as the recording element substrates 100. The first element substrate 100a and second element substrate 100b each include two rows of orifices, where multiple orifices 104 are aligned along the longitudinal direction (Y direction). The A-A cross section shown in FIG. 5B is a section passing through the first element substrate 100a when the liquid ejection unit 20 is viewed in the Y direction. The B-B cross section shown in FIG. 5C is a section passing through the first element substrate 100a and second element substrate 100b when the liquid ejection unit 20 is viewed in the Y direction. The C-C cross section shown in FIG. 5D is a section passing through the second element substrate 100b when the liquid ejection unit 20 is viewed in the Y direction.

The first element substrate 100a and second element substrate 100b are displaced from each other in the longitudinal direction (Y direction). In the short-side direction (X direction) perpendicular to the longitudinal direction, one longitudinal end portion of the first element substrate 100a is adjacent to one longitudinal end portion of the second element substrate 100b. The element substrates are arranged such that a portion of the orifice rows of the first element substrate 100a overlaps a portion of the orifice rows of the second element substrate 100b in the short-side direction, so that the apparent length of the orifice rows is extended. The liquid ejection unit 20 is configured with a plurality of first orifices 104a, a plurality of second orifices 104b, a plurality of third orifices 104c, and a plurality of fourth orifices 104d, all aligned along the longitudinal direction and forming first to fourth orifice rows.

In Example 1, the sub tank unit 500 includes a circulation pump and a pressure control reservoir inside, so that the liquid ejection head 10 is able to circulate the ink inside. The ink is circulated inside the liquid ejection head 10 by creating a pressure difference between upstream and downstream of the circulation pump in the direction of ink circulation.

The first element substrate 100a has a first orifice row formed by the first orifices 104a aligned along the longitudinal direction and connected to respective first pressure chambers 101a, and a third orifice row formed by the third orifices 104c aligned along the longitudinal direction and connected to respective third pressure chambers 101c. The first element substrate 100a also has a first shared supply path 102a and a first shared collection path 106a in communication with the first pressure chambers 101a, and a third shared supply path 102c and a third shared collection path 106c in communication with the third pressure chambers 101c. The first shared supply path 102a, first shared collection path 106a, third shared supply path 102c, and third shared collection path 106c all open to the opposite side from the ejection side of the first element substrate 100a, and are connected to the channels inside the connection member 200.

The second element substrate 100b has a second orifice row formed by the second orifices 104b aligned along the longitudinal direction and connected to respective second pressure chambers 101b, and a fourth orifice row formed by the fourth orifices 104d aligned along the longitudinal direction and connected to respective fourth pressure chambers 101d. The second element substrate 100b also has a second shared supply path 102b and a second shared collection path 106b in communication with the second pressure chambers 101b, and a fourth shared supply path 102d and a fourth shared collection path 106d in communication with the fourth pressure chambers 101d. The second shared supply path 102b, second shared collection path 106b, fourth shared supply path 102d, and fourth shared collection path 106d all open to the opposite side from the ejection side of the second element substrate 100b, and are connected to the channels inside the connection member 200.

In the short-side direction (X direction), the orifice rows are arranged in the order of the third, first, second, and fourth rows. Namely, a portion of the first orifice row formed by the first orifices 104a of the first element substrate 100a is adjacent to a portion of the second orifice row formed by the second orifices 104b of the second element substrate 100b in the short-side direction. The B-B cross section of FIG. 5A shown in FIG. 5C is a section passing through a first orifice 104a, a second orifice 104b, a third orifice 104c, and a fourth orifice 104d.

The channel member 300 includes a plurality of reservoirs 301, i.e., a first reservoir 301a, a second reservoir 301b, a third reservoir 301c, a fourth reservoir 301d, and a fifth reservoir 301e. The reservoirs 301 are each configured to be able to store liquid inside, and form ink channels between the sub tank unit 500 and the connection member 200. In the short-side direction (X direction), the reservoirs 301 are arranged in the order of the fourth reservoir 301d, second reservoir 301b, first reservoir 301a, third reservoir 301c, and fifth reservoir 301e.

The first reservoir 301a has a width in the longitudinal direction that substantially covers the length of the orifice rows of the first element substrate 100a and the orifice rows of the second element substrate 100b. The second reservoir 301b and fourth reservoir 301d have a width in the longitudinal direction that substantially covers the length of the orifice rows of the first element substrate 100a. The third reservoir 301c and fifth reservoir 301e have a width in the longitudinal direction that substantially covers the length of the orifice rows of the second element substrate 100b.

As shown in FIGS. 5B and 5C, the ink flows through respective channels in the first element substrate 100a in the order of the first reservoir 301a, first shared supply path 102a, first pressure chambers 101a, first shared collection path 106a, and second reservoir 301b. The ink also flows through respective channels in the first element substrate 100a in the order of the fourth reservoir 301d, third shared supply path 102c, third pressure chambers 101c, third shared collection path 106c, and second reservoir 301b. Namely, the ink is supplied from the first reservoir 301a and the fourth reservoir 301d, and collected in the second reservoir 301b in the first element substrate 100a.

As shown in FIGS. 5C and 5D, the ink flows through respective channels in the second element substrate 100b in the order of the first reservoir 301a, second shared supply path 102b, second pressure chambers 101b, second shared collection path 106b, and third reservoir 301c. The ink also flows through respective channels in the second element substrate 100b in the order of the fifth reservoir 301e, fourth shared supply path 102d, fourth pressure chambers 101d, fourth shared collection path 106d, and fourth reservoir 301d. Namely, the ink is supplied from the first reservoir 301a and the fifth reservoir 301e, and collected in the third reservoir 301c in the second element substrate 100b.

As described above, in the configuration of Example 1, the ink is supplied from the first reservoir 301a to the first pressure chambers 101a of the first element substrate 100a and the second pressure chambers 101b of the second element substrate 100b. The channels being shared by different recording element substrates 100 this way helps to minimize the increase in the width in the scanning direction (X direction) of the liquid ejection head 10 in the configuration where multiple recording element substrates 100 are arranged along the scanning direction (X direction).

Since air bubbles generated in the channels present around the pressure chambers 101 adversely affect ink ejection, a preferable configuration would be one that lets such air bubbles in the channels be removed by buoyancy. In a channel configuration where ink circulates as in Example 1, the flow of ink in the collection path moves the air bubbles away from the pressure chambers 101, while the flow of ink in the supply path moves the air bubbles closer to the pressure chambers 101. Namely, it is preferable to provide a bubble collection region for allowing air bubbles to accumulate away from the recording element substrates 100 particularly in the supply path, and to provide a mechanism for discharging the air bubbles to the outside of the liquid ejection head 10 by suction from outside the liquid ejection head 10 at regular intervals.

To provide a bubble collection region in the supply path, in Example 1, the sum of volumes of the first reservoir 301a, fourth reservoir 301d, and fifth reservoir 301e on the supply side is set greater than the sum of volumes of the second reservoir 301b and third reservoir 301c on the collection side. This configuration improves the efficiency of removing air bubbles generated inside the channels.

The channel through which ink is supplied from the sub tank unit 500 to each of the reservoirs in the channel member 300 may split inside the channel member 300, or inside the sub tank unit 500. Alternatively, a separate component for splitting the channel may be provided between the sub tank unit 500 and the channel member 300.

The channels through which the ink is collected from each of the reservoirs in the channel member 300 into the sub tank unit 500 may join inside the channel member 300, or inside the sub tank unit 500. Alternatively, a separate component for joining the channels may be provided between the sub tank unit 500 and the channel member 300. Alternatively, the same number of sub tank units 500 as the recording element substrates 100 may be provided. The configuration of the channels connecting the channel member 300 and the sub tank unit 500 may be applied to the following examples, too.

### Second Example

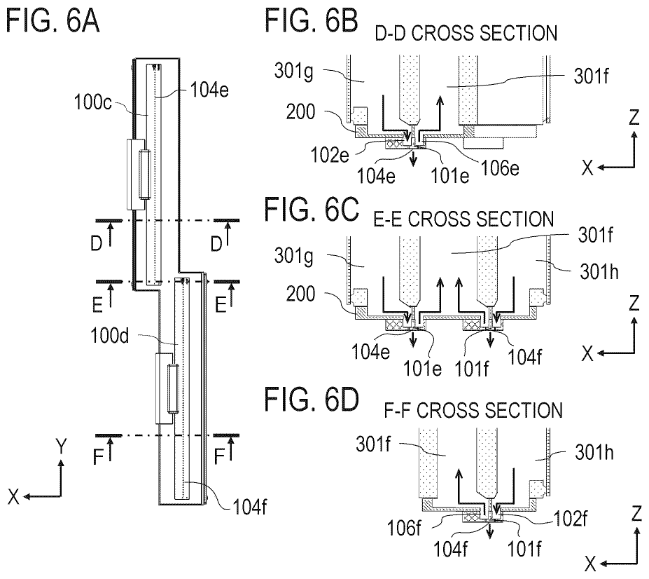

The channel configuration of the liquid ejection unit 20 according to Example 2 will be described with reference to FIGS. 6A to 6D. FIGS. 6A to 6D are illustrative diagrams of the channel configuration in the liquid ejection unit 20 according to Example 2. FIG. 6A is a bottom view of the liquid ejection unit 20. FIG. 6B is a D-D cross section of FIG. 6A. FIG. 6C is an E-E cross section of FIG. 6A. FIG. 6D is an F-F cross section of FIG. 6A. The arrows in FIGS. 6B to 6D indicate the directions of the flow of ink.

In Example 2, the liquid ejection unit 20 includes a first element substrate 100c and a second element substrate 100d as the recording element substrates 100. The first element substrate 100c and second element substrate 100d each include one orifice row where multiple orifices 104 are aligned along the longitudinal direction (Y direction). The D-D cross section shown in FIG. 6B is a section passing through the first element substrate 100c when the liquid ejection unit 20 is viewed in the Y direction. The E-E cross section shown in FIG. 6C is a section passing through the first element substrate 100c and second element substrate 100d when the liquid ejection unit 20 is viewed in the Y direction. The F-F cross section shown in FIG. 6D is a section passing through the second element substrate 100d when the liquid ejection unit 20 is viewed in the Y direction.

The first element substrate 100c and second element substrate 100d are displaced from each other in the longitudinal direction (Y direction). In the short-side direction (X direction) perpendicular to the longitudinal direction, one longitudinal end portion of the first element substrate 100c is adjacent to one longitudinal end portion of the second element substrate 100d. The element substrates are arranged such that a portion of the orifice row of the first element substrate 100c overlaps a portion of the orifice row of the second element substrate 100d in the short-side direction, so that the apparent length of the orifice rows is extended. The liquid ejection unit 20 is configured with a plurality of first orifices 104e and a plurality of second orifices 104f, both aligned along the longitudinal direction and forming first and second orifice rows.

In Example 2, the sub tank unit 500 includes a circulation pump and a pressure control reservoir inside, so that the liquid ejection head 10 is able to circulate the ink inside. The ink is circulated inside the liquid ejection head 10 by creating a pressure difference between upstream and downstream of the circulation pump in the direction of ink circulation.

The first element substrate 100c has a first orifice row formed by the first orifices 104e aligned along the longitudinal direction and connected to respective first pressure chambers 101e. The first element substrate 100c also has a first shared supply path 102e and a first shared collection path 106e in communication with the first pressure chambers 101e. The first shared supply path 102e and first shared collection path 106e both open to the opposite side from the ejection side of the first element substrate 100c, and are connected to the channels inside the connection member 200.

The second element substrate 100d has a second orifice row formed by the second orifices 104f aligned along the longitudinal direction and connected to respective second pressure chambers 101f. The second element substrate 100d also has a second shared supply path 102f and a second shared collection path 106f in communication with the second pressure chambers 101f. The second shared supply path 102f and second shared collection path 106f both open to the opposite side from the ejection side of the second element substrate 100d, and are connected to the channels inside the connection member 200.

In the short-side direction (X direction), one longitudinal end portion of the first orifice row is adjacent to one longitudinal end portion of the second orifice row. The E-E cross section of FIG. 6A shown in FIG. 6C is a section passing through a first orifice 104e and a second orifice 104f.

The channel member 300 includes a plurality of reservoirs 301, i.e., a first reservoir 301f, a second reservoir 301g, and a third reservoir 301h. The reservoirs 301 are each configured to be able to store liquid inside, and form ink channels between the sub tank unit 500 and the connection member 200. In the short-side direction (X direction), the reservoirs 301 are arranged in the order of the second reservoir 301g, first reservoir 301f, and third reservoir 301h.

The first reservoir 301f has a width in the longitudinal direction that substantially covers the length of the orifice row of the first element substrate 100c and the orifice row of the second element substrate 100d. The second reservoir 301g has a width in the longitudinal direction that substantially covers the length of the orifice row of the first element substrate 100c. The third reservoir 301h has a width in the longitudinal direction that substantially covers the length of the orifice row of the second element substrate 100d.

As shown in FIGS. 6B and 6C, the ink flows through respective channels in the first element substrate 100c in the order of the second reservoir 301g, first shared supply path 102e, first pressure chambers 101e, first shared collection path 106e, and first reservoir 301f. Namely, the ink is supplied from the second reservoir 301g, and collected in the first reservoir 301f in the first element substrate 100c.

As shown in FIGS. 6C and 6D, the ink flows through respective channels in the second element substrate 100d in the order of the third reservoir 301h, second shared supply path 102f, second pressure chambers 101f, second shared collection path 106f, and first reservoir 301f. Namely, the ink is supplied from the third reservoir 301h, and collected in the first reservoir 301f in the second element substrate 100d.

As described above, in the configuration of Example 2, the ink is collected from the first pressure chambers 101e of the first element substrate 100c and the second pressure chambers 101f of the second element substrate 100d to the first reservoir 301f. The channels being shared by different recording element substrates 100 this way helps to minimize the increase in the width in the scanning direction (X direction) of the liquid ejection head 10 in the configuration where multiple recording element substrates 100 are arranged along the scanning direction (X direction).

To provide a bubble collection region in the supply path, in Example 2, the sum of volumes of the second reservoir 301g and third reservoir 301h on the supply side is set greater than the volume of the first reservoir 301f on the collection side. This configuration improves the efficiency of removing air bubbles generated inside the channels.

### Third Example

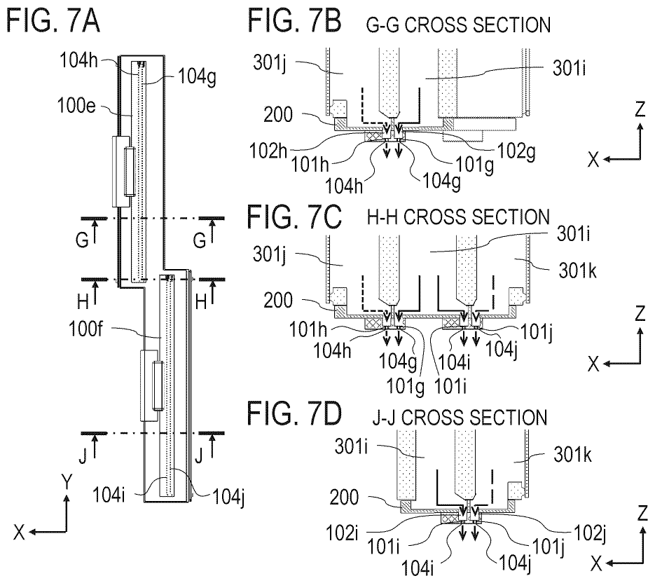

The channel configuration of the liquid ejection unit 20 according to Example 3 will be described with reference to FIGS. 7A to 7D. FIGS. 7A to 7D are illustrative diagrams of the channel configuration in the liquid ejection unit 20 according to Example 3. FIG. 7A is a bottom view of the liquid ejection unit 20. FIG. 7B is a G-G cross section of FIG. 7A. FIG. 7C is an H-H cross section of FIG. 7A. FIG. 7D is a J-J cross section of FIG. 7A. The arrows in FIGS. 7B to 7D indicate the directions of the flow of ink. In FIGS. 7B to 7D, different types of ink are represented by different types of lines.

In Example 3, the liquid ejection unit 20 includes a first element substrate 100e and a second element substrate 100f as the recording element substrates 100. The first element substrate 100e and second element substrate 100f each include two rows of orifices, where multiple orifices 104 are aligned along the longitudinal direction (Y direction). The G-G cross section shown in FIG. 7B is a section passing through the first element substrate 100e when the liquid ejection unit 20 is viewed in the Y direction. The H-H cross section shown in FIG. 7C is a section passing through the first element substrate 100e and second element substrate 100f when the liquid ejection unit 20 is viewed in the Y direction. The J-J cross section shown in FIG. 7D is a section passing through the second element substrate 100f when the liquid ejection unit 20 is viewed in the Y direction.

The first element substrate 100e and second element substrate 100f are displaced from each other in the longitudinal direction (Y direction). In the short-side direction (X direction) perpendicular to the longitudinal direction, one longitudinal end portion of the first element substrate 100e is adjacent to one longitudinal end portion of the second element substrate 100f. The element substrates are arranged such that a portion of the orifice rows of the first element substrate 100e overlaps a portion of the orifice rows of the second element substrate 100f in the short-side direction, so that the apparent length of the orifice rows is extended. The liquid ejection unit 20 is configured with a plurality of first orifices 104g, a plurality of second orifices 104h, a plurality of third orifices 104i, and a plurality of fourth orifice 104j, all aligned along the longitudinal direction and forming first to fourth orifice rows.

The first element substrate 100e has a first orifice row formed by the first orifices 104g aligned along the longitudinal direction and connected to respective first pressure chambers 101g, and a second orifice row formed by the second orifices 104h aligned along the longitudinal direction and connected to respective second pressure chambers 101h. The first element substrate 100e also has a first shared supply path 102g in communication with the first pressure chambers 101g, and a second shared supply path 102h in communication with the second pressure chambers 101h. The first shared supply path 102g and second shared supply path 102h both open to the opposite side from the ejection side of the first element substrate 100e, and are connected to the channels inside the connection member 200. The ink supplied to the first pressure chambers 101g and second pressure chambers 101h is not collected, and consumed only through the orifices 104 (nozzles).

The second element substrate 100f has a third orifice row formed by the third orifices 104i aligned along the longitudinal direction and connected to respective third pressure chambers 101i, and a fourth orifice row formed by the fourth orifices 104j aligned along the longitudinal direction and connected to respective fourth pressure chambers 101j. The second element substrate 100f also has a third shared supply path 102i in communication with the third pressure chambers 101i, and a fourth shared supply path 102j in communication with the fourth pressure chambers 101j. The third shared supply path 102i and fourth shared supply path 102j both open to the opposite side from the ejection side of the second element substrate 100f, and are connected to the channels inside the connection member 200. The ink supplied to the third pressure chambers 101i and fourth pressure chambers 101j is not collected, and consumed only through the orifices 104 (nozzles).

In the short-side direction (X direction), the orifice rows are arranged in the order of the second, first, third, and fourth rows. Namely, the first orifice row formed by the first orifices 104g of the first element substrate 100e and the third orifice row formed by the third orifices 104i of the second element substrate 100f are arranged adjacent to each other. The H-H cross section of FIG. 7A shown in FIG. 7C is a section passing through a first orifice 104g, a second orifice 104h, a third orifice 104i, and a fourth orifice 104j.

The channel member 300 includes a plurality of reservoirs 301, i.e., a first reservoir 301i, a second reservoir 301j, and a third reservoir 301k. The reservoirs 301 are each configured to be able to store liquid inside, and form ink channels between the sub tank unit 500 and the connection member 200. In the short-side direction (X direction), the reservoirs 301 are arranged in the order of the second reservoir 301j, first reservoir 301i, and third reservoir 301k.

The first reservoir 301i has a width in the longitudinal direction that substantially covers the length of the orifice rows of the first element substrate 100e and the orifice rows of the second element substrate 100f. The second reservoir 301j has a width in the longitudinal direction that substantially covers the length of the orifice rows of the first element substrate 100e. The third reservoir 301k has a width in the longitudinal direction that substantially covers the length of the orifice rows of the second element substrate 100f.

In Example 3, the liquid ejection head 10 is configured to be able to supply three types of ink from the sub tank unit 500 to the channel member 300. Two types of liquid are supplied to the first element substrate 100e via the first reservoir 301i and second reservoir 301j, and two types of liquid are supplied to the second element substrate 100f via the first reservoir 301i and third reservoir 301k. This liquid ejection head 10 has a non-circulatory configuration, i.e., the ink is not collected from the channel member 300 into the sub tank unit 500.

As shown in FIGS. 7B and 7C, a first ink flows through respective channels in the first element substrate 100e in the order of the first reservoir 301i, first shared supply path 102g, and first pressure chambers 101g, and is expelled from the first orifices 104g. A second ink flows through respective channels in the first element substrate 100e in the order of the second reservoir 301j, second shared supply path 102h, and second pressure chambers 101h, and is expelled from the second orifices 104h. Namely, the first ink is supplied from the first reservoir 301i, and the second ink is supplied from the second reservoir 301j, to the first element substrate 100e.

As shown in FIGS. 7C and 7D, the first ink flows through respective channels in the second element substrate 100f in the order of the first reservoir 301i, third shared supply path 102i, and third pressure chambers 101i, and is expelled from the third orifices 104i. A third ink flows through respective channels in the second element substrate 100f in the order of the second reservoir 301j, fourth shared supply path 102j, and fourth pressure chambers 101j, and is expelled from the fourth orifices 104j. Namely, the first ink is supplied from the first reservoir 301i, and the third ink is supplied from the third reservoir 301k, to the second element substrate 100f.

As described above, in the configuration of Example 3, the ink is supplied from the first reservoir 301i to the first pressure chambers 101g of the first element substrate 100e and the third pressure chambers 101i of the second element substrate 100f. The channels being shared by different recording element substrates 100 this way helps to minimize the increase in the width in the scanning direction (X direction) of the liquid ejection head 10 in the configuration where multiple recording element substrates 100 are arranged along the scanning direction (X direction).

With the configuration of Example 3, two or more types of ink (e.g., ink of two or more colors) can be ejected from the single recording element substrate 100. This allows the liquid ejection units 20 to be integrated, which helps to reduce the size of the liquid ejection head 10 as compared to the configuration where liquid ejection units 20 are provided separately for each color of ink, for example.

Note, the first ink, second ink, and third ink may be the same type of liquid. In this case, the ink can be supplied to respective pressure chambers from the sub tank unit 500 through the same channel that splits midway.

### Fourth Example

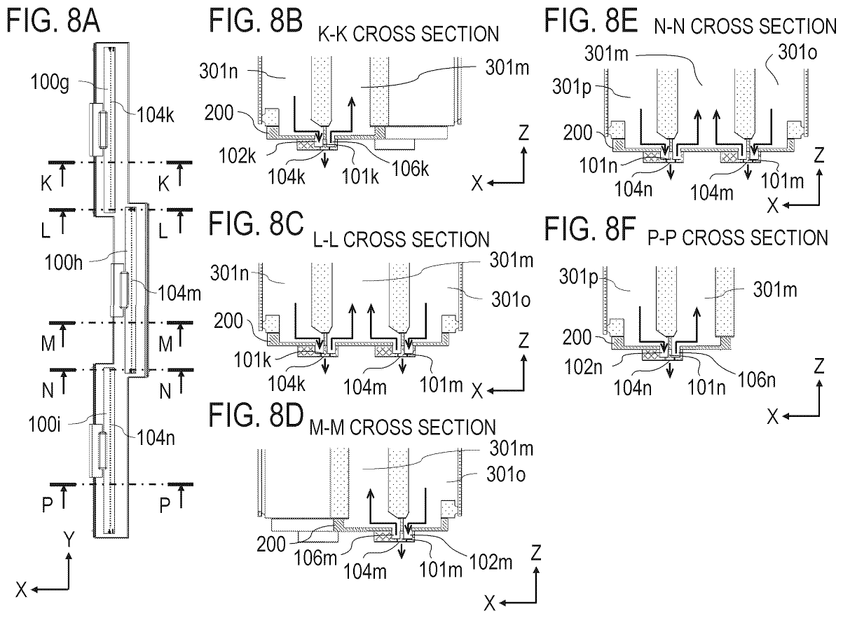

The channel configuration of the liquid ejection unit 20 according to Example 4 will be described with reference to FIGS. 8A to 8F. FIGS. 8A to 8F are illustrative diagrams of the channel configuration in the liquid ejection unit 20 according to Example 4. FIG. 8A is a bottom view of the liquid ejection unit 20. FIG. 8B is a K-K cross section of FIG. 8A. FIG. 8C is an L-L cross section of FIG. 8A. FIG. 8D is an M-M cross section of FIG. 8A. FIG. 8E is an N-N cross section of FIG. 8A. FIG. 8F is a P-P cross section of FIG. 8A. The arrows in FIGS. 8B to 8F indicate the directions of the flow of ink.

In Example 4, the liquid ejection unit 20 includes a first element substrate 100g, a second element substrate 100h, and a third element substrate 100i as the recording element substrates 100. The first element substrate 100g, second element substrate 100h, and third element substrate 100i each include one orifice row where multiple orifices 104 are aligned along the longitudinal direction (Y direction). The K-K cross section shown in FIG. 8B is a section passing through the first element substrate 100g when the liquid ejection unit 20 is viewed in the Y direction. The L-L cross section shown in FIG. 8C is a section passing through the first element substrate 100g and second element substrate 100h when the liquid ejection unit 20 is viewed in the Y direction. The M-M cross section shown in FIG. 8D is a section passing through the second element substrate 100h when the liquid ejection unit 20 is viewed in the Y direction. The N-N cross section shown in FIG. 8E is a section passing through the second element substrate 100h and third element substrate 100i when the liquid ejection unit 20 is viewed in the Y direction. The P-P cross section shown in FIG. 8F is a section passing through the third element substrate 100i when the liquid ejection unit 20 is viewed in the Y direction.

The first element substrate 100g, second element substrate 100h, and third element substrate 100i are displaced from each other in the longitudinal direction (Y direction). In the short-side direction (X direction) perpendicular to the longitudinal direction, one longitudinal end portion of the first element substrate 100g is adjacent to one longitudinal end portion of the second element substrate 100h. The other longitudinal end portion of the second element substrate 100h is adjacent to one longitudinal end portion of the third element substrate 100i. The first element substrate 100g and third element substrate 100i are arranged substantially at the same position in the short-side direction. In Example 4, a portion of the orifice row of the first element substrate 100g overlaps a portion of the orifice row of the second element substrate 100h in the short-side direction, and a portion of the orifice row of the second element substrate 100h overlaps a portion of the orifice row of the third element substrate 100i in the short-side direction. With the element substrates being thus arranged, the apparent length of the orifice rows is extended. The liquid ejection unit 20 is configured with a plurality of first orifices 104k, a plurality of second orifices 104m, and a plurality of third orifice 104n, all aligned along the longitudinal direction and forming first to third orifice rows.

In Example 4, the sub tank unit 500 includes a circulation pump and a pressure control reservoir inside, so that the liquid ejection head 10 is able to circulate the ink inside. The ink is circulated inside the liquid ejection head 10 by creating a pressure difference between upstream and downstream of the circulation pump in the direction of ink circulation.

The first element substrate 100g has a first orifice row formed by the first orifices 104k aligned along the longitudinal direction and connected to respective first pressure chambers 101k. The first element substrate 100g also has a first shared supply path 102k and a first shared collection path 106k in communication with the first pressure chambers 101k. The first shared supply path 102k and first shared collection path 106k both open to the opposite side from the ejection side of the first element substrate 100g, and are connected to the channels inside the connection member 200.

The second element substrate 100h has a second orifice row formed by the second orifices 104m aligned along the longitudinal direction and connected to respective second pressure chambers 101m. The second element substrate 100h also has a second shared supply path 102m and a second shared collection path 106m in communication with the second pressure chambers 101m. The second shared supply path 102m and second shared collection path 106m both open to the opposite side from the ejection side of the second element substrate 100h, and are connected to the channels inside the connection member 200.

The third element substrate 100i has a third orifice row formed by the third orifices 104n aligned along the longitudinal direction and connected to respective third pressure chambers 101n. The third element substrate 100i also has a third shared supply path 102n and a third shared collection path 106n in communication with the third pressure chambers 101n. The third shared supply path 102n and third shared collection path 106n both open to the opposite side from the ejection side of the third element substrate 100i, and are connected to the channels inside the connection member 200.

In the short-side direction (X direction), one longitudinal end portion of the first orifice row is adjacent to one longitudinal end portion of the second orifice row. One longitudinal end portion of the second orifice row is adjacent to one longitudinal end portion of the third orifice row. The L-L cross section of FIG. 8A shown in FIG. 8C is a section passing through a first orifice 104k and a second orifice 104m. The N-N cross section of FIG. 8A shown in FIG. 8E is a section passing through a second orifice 104m and a third orifice 104n.

The channel member 300 includes a plurality of reservoirs 301, i.e., a first reservoir 301m, a second reservoir 301n, a third reservoir 3010, and a fourth reservoir 301p. The reservoirs 301 are each configured to be able to store liquid inside, and form ink channels between the sub tank unit 500 and the connection member 200. In the short-side direction (X direction), the reservoirs 301 are arranged in the order of the second reservoir 301n, first reservoir 301m, and third reservoir 3010. The fourth reservoir 301p is located at a different position from the second reservoir 301n in the longitudinal direction (Y direction) and substantially at the same position in the short-side direction.

The first reservoir 301m has a width in the longitudinal direction that substantially covers the length of the orifice row of the first element substrate 100g, the orifice row of the second element substrate 100h, and the orifice row of the third element substrate 100i. The second reservoir 301n has a width in the longitudinal direction that substantially covers the length of the orifice row of the first element substrate 100g. The third reservoir 3010 has a width in the longitudinal direction that substantially covers the length of the orifice row of the second element substrate 100h. The fourth reservoir 301p has a width in the longitudinal direction that substantially covers the length of the orifice row of the third element substrate 100i.

As shown in FIGS. 8B and 8C, the ink flows through respective channels in the first element substrate 100g in the order of the second reservoir 301n, first shared supply path 102k, first pressure chambers 101k, first shared collection path 106k, and first reservoir 301m. Namely, the ink is supplied from the second reservoir 301n, and collected in the first reservoir 301m in the first element substrate 100g.

As shown in FIGS. 8C, 8D, and 8E, the ink flows through respective channels in the second element substrate 100h in the order of the third reservoir 3010, second shared supply path 102m, second pressure chambers 101m, second shared collection path 106m, and first reservoir 301m. Namely, the ink is supplied from the third reservoir 3010, and collected in the first reservoir 301m in the second element substrate 100h.

As shown in FIGS. 8E and 8F, the ink flows through respective channels in the third element substrate 100i in the order of the fourth reservoir 301p, third shared supply path 102n, third pressure chambers 101n, third shared collection path 106n, and first reservoir 301m. Namely, the ink is supplied from the fourth reservoir 301p, and collected in the first reservoir 301m in the third element substrate 100i.

As described above, in the configuration of Example 4, the ink is collected from the first pressure chambers 101k of the first element substrate 100g, the second pressure chambers 101m of the second element substrate 100h, and the third pressure chambers 101n of the third element substrate 100i into the first reservoir 301m. The channels being shared by different recording element substrates 100 this way helps to minimize the increase in the width in the scanning direction (X direction) of the liquid ejection head 10 in the configuration where multiple recording element substrates 100 are arranged along the scanning direction (X direction).

To provide a bubble collection region in the supply path, in Example 4, the sum of volumes of the second reservoir 301n, third reservoir 3010, and fourth reservoir 301p on the supply side is set greater than the volume of the first reservoir 301m on the collection side. This configuration improves the efficiency of removing air bubbles generated inside the channels.

While Example 4 showed a configuration in which three recording element substrates 100 are mounted on one liquid ejection unit 20, four or more recording element substrates 100 may be mounted to the liquid ejection unit 20 in applications of the present invention. The present invention is also applicable to a liquid ejection head 10 with three or more recording element substrates 100 and configured to eject several types of liquid in a non-circulatory configuration in which the ink is not circulated.

### Fifth Example

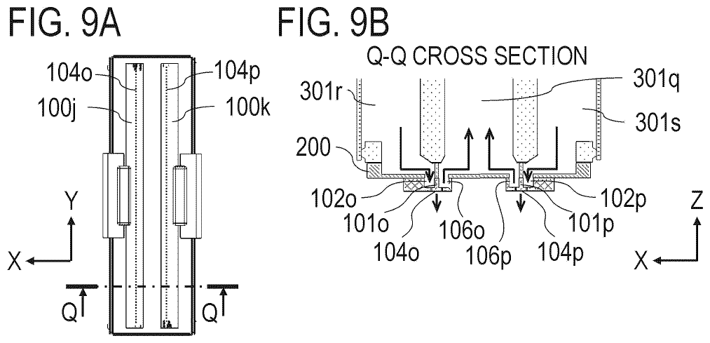

The channel configuration of the liquid ejection unit 20 according to Example 5 will be described with reference to FIGS. 9A and 9B. FIGS. 9A and 9B are illustrative diagrams of the channel configuration in the liquid ejection unit 20 according to Example 5. FIG. 9A is a bottom view of the liquid ejection unit 20. FIG. 9B is a Q-Q cross section of FIG. 9A. The arrows in FIG. 9B indicate the directions of the flow of ink.

In Example 5, the liquid ejection unit 20 includes a first element substrate 100j and a second element substrate 100k as the recording element substrates 100. The first element substrate 100j and second element substrate 100k each include one orifice row where multiple orifices 104 are aligned along the longitudinal direction (Y direction). The Q-Q cross section shown in FIG. 9B is a section passing through the first element substrate 100j and second element substrate 100k when the liquid ejection unit 20 is viewed in the Y direction.

The first element substrate 100j and second element substrate 100k are arranged substantially at the same position in the longitudinal direction (Y direction). In the short-side direction (X direction) perpendicular to the longitudinal direction, the first element substrate 100j is adjacent to the second element substrate 100k. With two orifice rows having substantially the same length (nozzle length) arranged side by side in the scanning direction (X direction) of the liquid ejection head 10, the number of ejecting points in one scan of the liquid ejection head 10 can be increased.

In Example 5, the sub tank unit 500 includes a circulation pump and a pressure control reservoir inside, so that the liquid ejection head 10 is able to circulate the ink inside. The ink is circulated inside the liquid ejection head 10 by creating a pressure difference between upstream and downstream of the circulation pump in the direction of ink circulation.

The first element substrate 100j has a first orifice row formed by the first orifices 1040 aligned along the longitudinal direction and connected to respective first pressure chambers 1010. The first element substrate 100j also has a first shared supply path 1020 and a first shared collection path 1060 in communication with the first pressure chambers 1010. The first shared supply path 1020 and first shared collection path 1060 both open to the opposite side from the ejection side of the first element substrate 100j, and are connected to the channels inside the connection member 200.

The second element substrate 100k has a second orifice row formed by the second orifices 104p aligned along the longitudinal direction and connected to respective second pressure chambers 101p. The second element substrate 100k also has a second shared supply path 102p and a second shared collection path 106p in communication with the second pressure chambers 101p. The second shared supply path 102p and second shared collection path 106p both open to the opposite side from the ejection side of the second element substrate 100k, and are connected to the channels inside the connection member 200.

In the short-side direction (X direction), the first orifice row and second orifice row are arranged adjacent to each other. The first and second orifice rows are arranged at the same position in the longitudinal direction (Y direction).

The channel member 300 includes a first reservoir 301q, a second reservoir 301r, and a third reservoir 301s. The reservoirs are each configured to be able to store liquid inside, and form ink channels between the sub tank unit 500 and the connection member 200. In the short-side direction (X direction), the reservoirs 301 are arranged in the order of the second reservoir 301r, first reservoir 301q, and third reservoir 301s.

The first reservoir 301q, second reservoir 301r, and third reservoir 301s have substantially the same width in the longitudinal direction that substantially covers the length of the orifice row of the first element substrate 100j and the orifice row of the second element substrate 100k.

As shown in FIG. 9B, the ink flows through respective channels in the first element substrate 100j in the order of the second reservoir 301r, first shared supply path 1020, first pressure chambers 1010, first shared collection path 1060, and first reservoir 301q. Namely, the ink is supplied from the second reservoir 301r, and collected in the first reservoir 301q in the first element substrate 100j.

As shown in FIG. 9B, the ink flows through respective channels in the second element substrate 100k in the order of the third reservoir 301s, second shared supply path 102p, second pressure chambers 101p, second shared collection path 106p, and first reservoir 301q. Namely, the ink is supplied from the third reservoir 301s, and collected in the first reservoir 301q in the second element substrate 100k.

As described above, in the configuration of Example 5, the ink is collected from the first pressure chambers 1010 of the first element substrate 100j and the second pressure chambers 101p of the second element substrate 100k into the first reservoir 301q. The channels being shared by different recording element substrates this way helps to minimize the increase in the width in the scanning direction (X direction) of the liquid ejection head 10 in the configuration where multiple recording element substrates 100 are arranged along the scanning direction (X direction).

To provide a bubble collection region in the supply path, in Example 5, the sum of volumes of the second reservoir 301r and third reservoir 301s on the supply side is set greater than the volume of the first reservoir 301q on the collection side. This configuration improves the efficiency of removing air bubbles generated inside the channels.

### Sixth Example

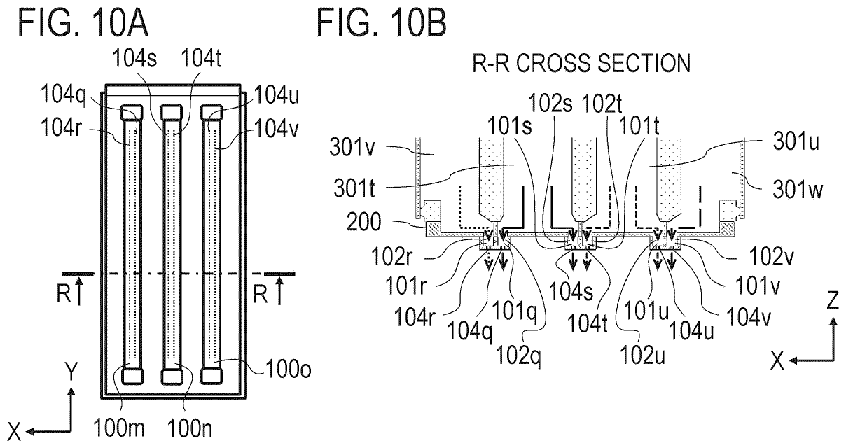

The channel configuration of the liquid ejection unit 20 according to Example 6 will be described with reference to FIGS. 10A and 10B. FIGS. 10A and 10B are illustrative diagrams of the channel configuration in the liquid ejection unit 20 according to Example 6. FIG. 10A is a bottom view of the liquid ejection unit 20. FIG. 10B is an R-R cross section of FIG. 10A. The arrows in FIG. 10B indicate the directions of the flow of ink. In FIG. 10B, different types of ink are represented by different types of lines.

In Example 6, the liquid ejection unit 20 includes a first element substrate 100m, a second element substrate 100n, and a third element substrate 1000 as the recording element substrates 100. The first element substrate 100m, second element substrate 100n, and third element substrate 1000 each include two rows of orifices, where multiple orifices 104 are aligned along the longitudinal direction (Y direction). The R-R cross section shown in FIG. 10B is a section passing through the first element substrate 100m, second element substrate 100n, and third element substrate 1000 when the liquid ejection unit 20 is viewed in the Y direction.

The first element substrate 100m, second element substrate 100n, and third element substrate 1000 are arranged substantially at the same position in the longitudinal direction (Y direction). In the short-side direction (X direction) perpendicular to the longitudinal direction, the recording element substrates 100 are arranged in parallel in the order of the first element substrate 100m, second element substrate 100n, and third element substrate 1000. Namely, the second element substrate 100n is between and adjacent to both of the first element substrate 100m and the third element substrate 1000. With six orifice rows having substantially the same length (nozzle length) arranged side by side in the scanning direction (X-direction) of the liquid ejection head 10, the number of ejecting points in one scan of the liquid ejection head 10 can be increased.

The first element substrate 100m has a first orifice row formed by the first orifices 104q aligned along the longitudinal direction and connected to respective first pressure chambers 101q, and a second orifice row formed by the second orifices 104r aligned along the longitudinal direction and connected to respective second pressure chambers 101r. The first element substrate 100m also has a first shared supply path 102q in communication with the first pressure chambers 101q, and a second shared supply path 102r in communication with the second pressure chambers 101r. The first shared supply path 102q and second shared supply path 102r both open to the opposite side from the ejection side of the first element substrate 100m, and are connected to the channels inside the connection member 200. The ink supplied to the first pressure chambers 101q and second pressure chambers 101r is not collected, and consumed only through the orifices 104 (nozzles).

The second element substrate 100n has a third orifice row formed by the third orifices 104s aligned along the longitudinal direction and connected to respective third pressure chambers 101s, and a fourth orifice row formed by the fourth orifices 104t aligned along the longitudinal direction and connected to respective fourth pressure chambers 101t. The second element substrate 100n also has a third shared supply path 102s in communication with the third pressure chambers 101s, and a fourth shared supply path 102t in communication with the fourth pressure chambers 101t. The third shared supply path 102s and fourth shared supply path 102t both open to the opposite side from the ejection side of the second element substrate 100n, and are connected to the channels inside the connection member 200. The ink supplied to the third pressure chambers 101s and fourth pressure chambers 101t is not collected, and consumed only through the orifices 104 (nozzles).

The third element substrate 1000 has a fifth orifice row formed by fifth orifices 104u aligned along the longitudinal direction and connected to respective fifth pressure chambers 101u, and a sixth orifice row formed by sixth orifices 104v aligned along the longitudinal direction and connected to respective sixth pressure chambers 101v. The third element substrate 1000 also has a fifth shared supply path 102u in communication with the fifth pressure chambers 101u, and a sixth shared supply path 102v in communication with the sixth pressure chambers 101v. The fifth shared supply path 102u and sixth shared supply path 102v both open to the opposite side from the ejection side of the third element substrate 1000, and are connected to the channels inside the connection member 200. The ink supplied to the fifth pressure chambers 101u and sixth pressure chambers 101v is not collected, and consumed only through the orifices 104 (nozzles).

In the short-side direction (X direction), the orifice rows are arranged in the order of the second, first, third, fourth, fifth, and sixth rows. Namely, the first orifice row formed by the first orifices 104q of the first element substrate 100m and the third orifice row formed by the third orifices 104s of the second element substrate 100n are arranged adjacent to each other. The fourth orifice row formed by the fourth orifices 104t of the second element substrate 100n and the fifth orifice row formed by the fifth orifices 104u of the third element substrate 1000 are arranged adjacent to each other. The first orifice row, second orifice row, third orifice row, fourth orifice row, fifth orifice row, and sixth orifice row are arranged at the same position in the longitudinal direction (Y direction).

The channel member 300 includes a first reservoir 301t, a second reservoir 301u, a third reservoir 301v, and a fourth reservoir 301w. The reservoirs are each configured to be able to store liquid inside, and form ink channels between the sub tank unit 500 and the connection member 200. In the short-side direction (X direction), the reservoirs 301 are arranged in the order of the third reservoir 301v, first reservoir 301t, second reservoir 301u, and fourth reservoir 301w.

The first reservoir 301t, second reservoir 301u, third reservoir 301v, and fourth reservoir 301w have substantially the same width in the longitudinal direction that substantially covers the length of the orifice rows of the first element substrate 100m, second element substrate 100n, and third element substrate 1000.

In Example 6, the liquid ejection head 10 is configured to be able to supply four types of ink from the sub tank unit 500 to the channel member 300. Two types of liquid are supplied to the first element substrate 100m via the first reservoir 301t and third reservoir 301v. Two types of liquid are supplied to the second element substrate 100n via the first reservoir 301t and second reservoir 301u. Two types of liquid are supplied to the third element substrate 1000 via the second reservoir 301u and fourth reservoir 301w. This liquid ejection head 10 has a non-circulatory configuration, i.e., the ink is not collected from the channel member 300 into the sub tank unit 500.

As shown in FIG. 10B, a first ink flows through respective channels in the first element substrate 100m in the order of the first reservoir 301t, first shared supply path 102q, and first pressure chambers 101q, and is expelled from the first orifices 104q. A second ink flows through respective channels in the first element substrate 100m in the order of the third reservoir 301v, second shared supply path 102r, and second pressure chambers 101r, and is expelled from the second orifices 104r. Namely, the first ink is supplied from the first reservoir 301t, and the second ink is supplied from the third reservoir 301v, to the first element substrate 100m.

As shown in FIG. 10B, the first ink flows through respective channels in the second element substrate 100n in the order of the first reservoir 301t, third shared supply path 102s, and third pressure chambers 101s, and is expelled from the third orifices 104s. A third ink flows through respective channels in the second element substrate 100n in the order of the second reservoir 301u, fourth shared supply path 102t, and fourth pressure chambers 101t, and is expelled from the fourth orifices 104t. Namely, the first ink is supplied from the first reservoir 301t, and the third ink is supplied from the second reservoir 301u, to the second element substrate 100n.

As shown in FIG. 10B, a third ink flows through respective channels in the third element substrate 1000 in the order of the second reservoir 301u, fifth shared supply path 102u, and fifth pressure chambers 101u, and is expelled from the fifth orifices 104u. A fourth ink flows through respective channels in the third element substrate 1000 in the order of the fourth reservoir 301w, sixth shared supply path 102v, and sixth pressure chambers 101v, and is expelled from the sixth orifices 104v. Namely, the third ink is supplied from the second reservoir 301u, and the fourth ink is supplied from the fourth reservoir 301w, to the third element substrate 1000.

As described above, in the configuration of Example 6, the ink is supplied from the first reservoir 301t to the first pressure chambers 101q of the first element substrate 100m and the third pressure chambers 101s of the second element substrate 100n. Furthermore, in the configuration of Example 6, the ink is supplied from the second reservoir 301u to the fourth pressure chambers 101t of the second element substrate 100n and the fifth pressure chambers 101u of the third element substrate 1000. The channels being shared by different recording element substrates 100 this way helps to minimize the increase in the width in the scanning direction (X direction) of the liquid ejection head 10 in the configuration where multiple recording element substrates 100 are arranged along the scanning direction (X direction).

With the configuration of Example 6, two or more types of ink (e.g., ink of two or more colors) can be ejected from the single recording element substrate 100. This allows the liquid ejection units 20 to be integrated, which helps to reduce the size of the liquid ejection head 10 as compared to the configuration where liquid ejection units 20 are provided separately for each color of ink, for example.

Note, the first ink, second ink, third ink, and fourth ink may be the same type of liquid. In this case, the ink can be supplied to various pressure chambers from the sub tank unit 500 through the same channel that splits midway.

As described above, the configuration of the first embodiment allows shared use of channels for supplying liquid to a plurality of recording element substrates 100 irrespective of the number of recording element substrates 100, the channel configuration including the openings, or whether the ink is circulated or not. This helps to minimize an increase in the size of the liquid ejection head 10.

The configurations of various examples described above can be combined. For example, two or more orifice rows may be provided to each recording element substrate 100 as in Example 1 in the liquid ejection head 10 where three or more recording element substrates 100 are provided as in Example 4.

In some of the examples described above, a circulation pump is provided inside the liquid ejection head so that the ink can be circulated in the liquid ejection head 10. The present invention is not limited to this configuration. For example, the present invention is applicable also to a configuration where a circulation pump is provided outside the liquid ejection head 10 to circulate the liquid, or to a configuration where the liquid is circulated by means of the connection member 200 and channel member 300 upstream of the recording element substrates 100.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-090882, filed on Jun. 1, 2023, which is hereby incorporated by reference herein in its entirety.

What is claimed is:

1. A liquid ejection head comprising:
a first element substrate including a first orifice row formed by a plurality of orifices, which are configured to eject liquid and are aligned along a first direction, and a first pressure chamber provided correspondingly to an orifice of the first orifice row;
a second element substrate including a second orifice row formed by a plurality of orifices, which are configured to eject liquid and are aligned along the first direction, the second orifice row having at least a portion that is adjacent to the first orifice row in a second direction perpendicular to the first direction, and a second pressure chamber provided correspondingly to an orifice of the second orifice row; and
a channel-forming member including a plurality of reservoirs storing liquid, the plurality of reservoirs comprise a first reservoir in communication with the first pressure chamber and the second pressure chamber, a second reservoir in communication with the first pressure chamber, and a third reservoir in communication with the second pressure chamber.

2. The liquid ejection head according to claim 1, wherein
a portion of liquid supplied from the first reservoir to the first pressure chamber is collected in the second reservoir, and a portion of liquid supplied from the first reservoir to the second pressure chamber is collected in the third reservoir.

3. The liquid ejection head according to claim 2, wherein
the second orifice row is displaced in the first direction relative to the first orifice row.

4. The liquid ejection head according to claim 3, wherein
the first element substrate includes a third orifice row formed by a plurality of orifices, which are configured to eject liquid and are aligned along the first direction, and a third pressure chamber provided correspondingly to an orifice of the third orifice row, and the second element substrate includes a fourth orifice row formed by a plurality of orifices, which are configured to eject liquid and are aligned along the first direction, and a fourth pressure chamber provided correspondingly to an orifice of the fourth orifice row, wherein
the second reservoir is in communication with the third pressure chamber, and the third reservoir is in communication with the fourth pressure chamber, and wherein
the plurality of reservoirs comprises a fourth reservoir in communication with the third pressure chamber, and a fifth reservoir in communication with the fourth pressure chamber.

5. The liquid ejection head according to claim 4, wherein
a portion of liquid supplied from the fourth reservoir to the third pressure chamber is collected in the second reservoir, and a portion of liquid supplied from the fifth reservoir to the fourth pressure chamber is collected in the third reservoir.

6. The liquid ejection head according to claim 5, wherein
a width of the first reservoir in the first direction is greater than those of the second reservoir, the third reservoir, the fourth reservoir, and the fifth reservoir in the first direction.

7. The liquid ejection head according to claim 5, wherein
a sum of volumes of the first reservoir, the fourth reservoir, and the fifth reservoir is greater than a sum of volumes of the second reservoir and the third reservoir.

8. The liquid ejection head according to claim 1, wherein
a portion of liquid supplied from the second reservoir to the first pressure chamber is collected in the first reservoir, and a portion of liquid supplied from the third reservoir to the second pressure chamber is collected in the first reservoir.

9. The liquid ejection head according to claim 8, wherein
the second orifice row is displaced in the first direction relative to the first orifice row.

10. The liquid ejection head according to claim 9, wherein
a width of the first reservoir in the first direction is greater than those of the second reservoir and the third reservoir in the first direction.

11. The liquid ejection head according to claim 8, wherein
a sum of volumes of the second reservoir and the third reservoir is greater than a volume of the first reservoir.

12. The liquid ejection head according to claim 8 wherein
the second orifice row is arranged at a same position as the first orifice row in the first direction.

13. The liquid ejection head according to claim 1, further comprising:
a third element substrate including a third orifice row formed by a plurality of orifices, which are configured to eject liquid and are aligned along the first direction, and a third pressure chamber provided correspondingly to an orifice of the third orifice row, wherein
the first reservoir is in communication with the third pressure chamber, wherein
the second orifice row is displaced in the first direction relative to the first orifice row, and the third orifice row is arranged at a same position as the first orifice row in the second direction while being displaced in the first direction relative to the second orifice row such that a portion of the third orifice row is adjacent to the second orifice row in the second direction, and wherein
the plurality of reservoirs comprise a fourth reservoir in communication with the third pressure chamber.

14. The liquid ejection head according to claim 13, wherein
a portion of liquid supplied from the second reservoir to the first pressure chamber is collected in the first reservoir, a portion of liquid supplied from the third reservoir to the second pressure chamber is collected in the first reservoir, and a portion of liquid supplied from the fourth reservoir to the third pressure chamber is collected in the first reservoir.

15. The liquid ejection head according to claim 14, wherein
a sum of volumes of the second reservoir, the third reservoir, and the fourth reservoir is greater than a volume of the first reservoir.

16. A liquid ejection head comprising:
a first element substrate including a first orifice row formed by a plurality of orifices, which are configured to eject liquid and are aligned along a first direction, a first pressure chamber provided correspondingly to an orifice of the first orifice row, a second orifice row formed by a plurality of orifices, which are configured to eject liquid and are aligned along the first direction, and a second pressure chamber provided correspondingly to an orifice of the second orifice row;
a second element substrate including a third orifice row formed by a plurality of orifices, which are configured to eject liquid and are aligned along the first direction, the third orifice row having at least a portion that is adjacent to the second orifice row in a second direction perpendicular to the first direction, a third pressure chamber provided correspondingly to an orifice of the third orifice row, a fourth orifice row formed by a plurality of orifices, which are configured to eject liquid and are aligned along the first direction, and a fourth pressure chamber provided correspondingly to an orifice of the fourth orifice row; and
a channel-forming member including a plurality of reservoirs storing liquid, the plurality of reservoirs comprise a first reservoir in communication with the first pressure chambers and the third pressure chambers, a second reservoir in communication with the second pressure chambers, and a third reservoir in communication with the fourth pressure chambers.

17. The liquid ejection head according to claim 16, wherein
the third orifice row and the fourth orifice row are displaced in the first direction relative to the first orifice row and the second orifice row.

18. The liquid ejection head according to claim 17, wherein
a width of the first reservoir in the first direction is greater than those of the second reservoir and the third reservoir in the first direction.

19. The liquid ejection head according to claim 16, further comprising:
a third element substrate including a fifth orifice row formed by a plurality of orifices, which are configured to eject liquid and are aligned along the first direction, a fifth pressure chamber provided correspondingly to an orifice of the fifth orifice row, a sixth orifice row formed by a plurality of orifices, which are configured to eject liquid and are aligned along the first direction, and a sixth pressure chamber provided correspondingly to an orifice of the sixth orifice row, wherein
the second reservoir is in communication with the fifth pressure chambers, and wherein
the plurality of reservoirs comprises a fourth reservoir in communication with the sixth pressure chambers.

20. The liquid ejection head according to claim 19, wherein
the second orifice row, the third orifice row, the fourth orifice row, the fifth orifice row, and the sixth orifice row are arranged at a same position as the first orifice row in the first direction.
